(19) United States
(12) Patent Application Publication
(10) Pub. No.: US 2009/0032400 A1
(43) Pub. Date: Feb. 5, 2009

(54) Use of support materials in capillary electrochromatography

(75) Inventor: Angelika Muscate-Magnussen, Hamburg (DE)

Correspondence Address: JACOBSON HOLMAN PLLC, 400 SEVENTH STREET N.W., SUITE 600, WASHINGTON, DC, 20004, US

(73) Assignee: Evotec BioSystems AG

(21) Appl. No.: 12/078,533

(22) Filed: Apr. 1, 2008

Related U.S. Application Data
(63) Continuation of application No. 09/933,811, filed on Aug. 22, 2001, now abandoned.
Application No. 09/933,811 is a continuation-in-part of application No. PCT/EP00/01393, filed on Feb. 21, 2000.

(30) Foreign Application Priority Data
Feb. 22, 1999 (DE) 199 07 296.5
Feb. 3, 2000 (DE) 100 04 673.8

(51) Int. Cl. G01N 27/26

(52) U.S. Cl. 204/452; 204/601; 204/603; 204/451

(57) ABSTRACT

Use of a support material for capillary electrochromatography (CEC), characterized in that the support material has a porous design and a surface which consists of an outer surface and a pore surface, wherein the outer surface has regions of different derivatization and/or functionality from that of the pore surface.

This is a continuation in part of PCT/EP00/01393, filed 21 Feb. 2000, the disclosure of which is incorporated herein by reference.

The present invention relates to the use of support materials in capillary electrochromatography (CEC).

In general, analytical methods are at best selective; however, only a few, if any, are really specific. Consequently, when an analysis is performed, separation of the analyte from interfering accompanying substances is inevitable.

In chromatographic separations, the sample is dissolved in a mobile phase which may be, for example, a gas, a liquid or a supercritical fluid. The mobile phase is moved through a stationary phase which is not miscible with it and is accommodated in a column, for example, or fixed at a solid surface. The two phases are selected in such a way that the sample components become distributed between the mobile and stationary phases in different ratios. The components which are strongly retained by the stationary phase travel on slowly with the mobile phase. In contrast, the components which are weakly retained by the stationary phase travel fast. Due to these differences, the sample components will separate into discrete bands.

A chromatographic concept which combines the advantages of capillary liquid chromatography (e.g., HPLC) and capillary electrophoresis (CE) is the so-called capillary electrochromatography (CEC). Essentially, CEC can be considered a hybrid of HPLC and CE (Colon et al., Analytical Chemistry News & Features 1995; Aug. 1, 461A-467A). As in HPLC, the components of a sample are separated due to a different distribution between stationary and mobile phases. In addition however, as in CE, an electro-osmotic flow is produced by applying a voltage. The separations can be performed isocratically or with a gradient. The columns are preferably filled with silica gel particles, typically having particle diameters in a range of from 1 to 5 μm.

An advantage of this method is the possibility of separating anionic, cationic and neutral molecules. However, a great problem lies in the analysis of complex samples, especially biological ones. The latter, such as hemolyzed blood, plasma, serum, milk, saliva, liquor, fermenter broth, urine, supernatants of cell culture, food and tissue homogenizates or extracts from natural products, contain a high proportion of matrix components, such as proteins and salts, in addition to the analyte.

Proteins and other macromolecules are precipitated, for example, by high proportions of organic solvents in the mobile phase, or non-specifically and irreversibly bound by residual silanol groups at the surface of a chromatographic support, or denatured (J. R. Verart et al., J. Chromatography A 1999; 471-475). When a porous stationary phase is used, the proteins and other macromolecules block the access to the pores and thus reduce the number of chromatographic adsorption centers. Due to the reduced exchange of materials between the stationary and mobile phases connected therewith, these processes result in a loss of capacity and selectivity of the column. In addition, non-specific adsorption results in variations of the electro-osmotic flow and in non-reproducible retention times of the analytes. In all cases, the CEC column is highly damaged or rendered useless. Therefore, it is necessary to remove these matrix components from the sample prior to the CEC analysis.

These problems are all the more important since they pertain to determinations which are performed in a high number: for example, metabolic studies, therapy control, determination of endogenous substances, quality control of foods, or the high-throughput screening for potential pharmacologically active substances, especially using extracts from natural products.

In addition to methods of dialysis, ultrafiltration, protein precipitation, liquid/liquid extraction, common sample processing methods include, in particular, methods of solid phase extraction, for example, cartridge methods or the use of precolumns, preferably filled with silica gel particles, the elution of the analyte preferably being effected by liquid desorption (HPLC). The use of precolumns in HPLC for separating analytes from samples containing proteins or a matrix is described, for example, by Rudolphi and Boos (LC·GC 15 (9), 814-823, 1997).

However, the necessary sample pretreatment steps are often time-, cost- and labor-intensive, and due to the necessary transfer of the analyte to a separating column, result in a volume enlargement of the sample, which results in a loss of selectivity and sensitivity of the separating method. In addition, sample volumes of at least 10 μl are necessary to perform these sample pretreatment steps, which precludes, in particular, the use thereof for sample processing in high-throughput processes, in which only nl to a few μl samples are available.

Pinkerton et al. (U.S. Pat. No. 4,544,485) claim a support material for liquid chromatography on a silica or glass basis which enables the separation of proteins or macromolecules from a sample. The so-called internal surface reverse phase (ISRP) material is characterized by a hydrophilic outer surface and a hydrophobic inner or pore surface. In one modification, for example, glycine is bound to the outer particle surface. The pore surface is characterized by polypeptides bound through glycerolpropyl, especially tripeptides. These result in a limited accessibility of the pores. Smaller target molecules (analytes) gain access to the pores while the large matrix molecules remain excluded.

Boos et al. (LC·GC 1997, 15, 602-611; LC·GC 1996, 14, 554-560) describe a support material based on alkyldiol-silica (ADS) which ensures the quantitative separation of proteins and other macromolecular components. It is characterized by a surface which is inert towards biomolecules, and its pores are occupied by alkyl groups. Its pore size permits small target molecules (analytes) access while the large matrix molecules remain excluded. This material was especially developed for HPLC analyses.

L. J. Glunz et al. (J. of Liquid Chromatography 1992, 15, 1361-1379) also developed a so-called restricted access material based on silica for HPLC, whose functional mechanism relies on a semipermeable membrane (SPS) on the particle surface. Occupation of the surface of the support material with polyethylene glycol or polyoxyethylene produces a network which permits only small analytes access to the pores. Thus, macromolecules are not able to access the pores. The pore surface is occupied by hydrophobic groups, especially phenyl groups, C18, C8 and nitrile.

Further restricted access materials especially developed for HPLC and based on porous materials whose outer surface has a different derivatization from that of the pore surface include, in particular, ChromSper 5 Biomatrix (Chrompack), Hisep (Suplelco) and Capcell Pak MF (Shiseido).

The methods of capillary electrochromatography and HPLC are considerably distinct, in particular, by the electro-osmotic forces occurring in CEC. Thus, materials and conditions suitable for HPLC cannot be simply transferred to the CEC method (Colon et al., Analytical Chemistry & Features 1997; Aug. 1).

Therefore, it was all the more surprising that the use of support materials characterized by having a porous design and a surface which consists of an outer surface and a pore surface, wherein the outer surface has regions of different derivatization and/or functionality from that of the pore surface, in capillary electrochromatography enables an essentially quantitative separation of the analyte from other sample components, especially proteins and other macromolecular components (sample matrix) of the sample.

The term “derivatization” relates to the covalent or, in particular, adsorptive binding of molecules to the surface of the support material. This may be, for example, synthetic or natural polymers which, as a chemical diffusion barrier, prevent macromolecules of the sample matrix from adsorbing to or denaturing on the support material. The term “functionalization” refers to the properties of a respective region, in particular. Thus, particular regions of the support material can be hydrophobic while other regions have hydrophilic properties. Such a functionalization can be achieved by a different derivatization of the regions. Thus, different molecules (e.g., fatty acids in one region, alcohols in another) can be employed. However, it is also possible to achieve a different functionalization by varying the coverage of regions with identical molecules.

The use of the support material in CEC according to the invention permits to separate the analyte from other components of the sample without diluting it. In connection with isotachophoresis, in one embodiment, it is possible to transfer the analyte onto a separating column, especially another CEC column or a μ-HPLC column, without significantly increasing the volume. Even sample volumes of ≦10 μl can be processed.

In the use of the support material according to the invention, the reproducibility with respect to plate numbers, retention time and resolution of the column is retained even after the repeated injection of complex samples, especially samples containing serum and cell culture media.

In another embodiment, the use of the support material according to the invention even permits the combined sample processing and separation of complex samples on a single CEC column. With respect to the separating performance, sensitivity, signal-to-noise ratio, selectivity, service life of the column and costs, it is equivalent or even superior to sample processing and separation performed on separate columns. This for the first time enables the use of such a system in a high-throughput process, such as the high-throughput screening for potential pharmacologically active substances.

It may be preferred to pass the analytes separated by CEC, preferably in a fully automatic manner, to another analysis, especially using fluorescence correlation spectroscopy, during which the interaction of the analyte with other molecules is detected, in particular. This can be, for example, receptor-ligand interactions.

Thus, the use of the support material according to the invention is altogether characterized by the following properties:
there is a possibility of repeated direct injection of untreated samples, especially biological samples, on one CEC column;
the protein matrix is quantitatively removed;
the analyte can be concentrated at the upper brim of the column and quantitatively separated off and into its components independently of the matrix;
high separating performance, sensitivity, accuracy, very good signal-to-noise ratio;
high extent of reproducibility with respect to plate numbers, retention time and resolution of separation in the column;
automatic operation is possible;
high number of analytical runs, continuous operation of the column;
low costs per analysis.

It is particularly advantageous if the outer and/or pore surface of the support material is derivatized and/or functionalized with hydrophobic and/or hydrophilic groups and/or ion-exchange groups and/or affinity ligands and/or chiral groups. Thus, the support material can be designed individually with respect to its chemical and/or physical separating properties.

The functional groups listed in the following are particularly suitable:

| | | Ion-exchange | |
|---|---|---|---|
| Hydrophilic groups | Hydrophobic groups | groups | Affinity ligands |
| alcohols, preferably | alkyl, preferably C1- | —(CH₂)ₓSO₃H; | antibodies; |
| glycols and diols; | C40; | —(CF₂)ₓSO₃H; | Fab fragments; |
| amides, preferably | aryl, preferably phenyl; | -aryl-SO₃H; | proteins, especially |
| hydrophilic peptides, | benzyl; | —(CH₂)ₓ—⁺NR₃⁻OH; | bovine serum |
| such as Ser-L-Gly | nitrophenylethyl; | —(CF₂)ₓ—⁺NR₃⁻OH; | albumin; |
| dipeptide; | 2-(1-pyrenyl)ethyl; | -aryl—⁺NR₃⁻OH; | receptors; |
| calixarenes; | halides; | —(CH₂)ₓ—CO₂H; | metal chelates, |
| carbohydrates; | cyano; | —(CF₂)ₓ—CO₂H; | especially NTA-nickel; |
| hydrophilic amino | SH; | -aryl-CO₂H, | borate; |
| acids, preferably | hydrophobic peptides, | preferably benzyl- | DNA; |
| serine or glycine; | preferably Glycine-L- | CO₂H; | oligonucleotides; |
| proteins, preferably | phenylalanine; | R = -alkyl, —H; | antisense; |
| α-acid glycoprotein; | esters, preferably | x = 0-30 | molecular imprinted |
| nitroalkyl | carboxylic acid and fatty | | polymer |
| | acid esters; | | |
| | alkoxy; | | |
| | ketones | | |

For the separation of mixtures of enantiomers, chiral phases with the following functional ligands are particularly suitable: cyclodextrin, amylose tris(3,5-dimethylphenylcarbamate), bovine serum albumin, ristocetin, 1,2-diphenylethyldiamine and vancomycin.

A number of suitable support materials are available with an outer diameter of 5 μm, especially ChromSper 5 Biomatrix (Chrompack), ISRP GFF II and SPS (Regis Technologies), Hisep (Suplelco) and Capcell Pak MF (Shiseido).

In addition to materials such as ChromSper 5 Biomatrix (Chrompack), ISRP GFF II and SPS (Regis Technologies), Hisep (Suplelco) and Capcell Pak MF (Shiseido), the skilled person can recur to different methods for the preparation of the stationary phases for the use according to the invention.

As the starting material, inorganic materials, e.g., silicate-containing materials, especially porous silicate-containing materials, or glass can be employed. These can be modified with glycerolpropyl on their outer and/or pore surface, as described, for example, in U.S. Pat. No. 4,544,485. A large number of starting materials are also commercially available, such as Hypersil (Separations Group), Spherisorb (Phase Separations), Nucleosil (Macherey-Nagel Co.), Zorbax Sil (DuPont), Micro-pack Si (Varian- Associates), or Baker Silica gel (Baker Chem. Co.).

Organic polymers or copolymers containing hydroxy groups may also be used as the starting material.

Also suitable as the starting material are hydrophilic organic copolymers of, for example, oligoethylene glycol, glycidyl methacrylate or pentaerythritol dimethacrylate. They can be functionalized by acrylamide derivatives of formula CH₂═CH—CO—NHR, R being, for example, a linear and/or branched-chain aliphatic sulfonic acid group and/or carboxylic acid group. In particular, mixed polymers of glycidyl methacrylate and ethylene dimethacrylate, dihydroxypropyl methacrylate and ethylene dimethacrylate, or glycerol monomethacrylate and glycerol dimethacrylate are also suitable.

For the synthesis, in particular, of base materials in a grain size range of smaller than 5 μm, a modification of the method of Stöber (Christian Kaiser, doctoral thesis, Johannes-Gutenberg-Universität, 1996, W. Stöber et al., J. Colloid Interface Sci. 26, 62, 1968) can be used for the preparation of high-order mesoporous materials based on silica gel. The skilled person may also recur to, for example, the method described under DE 195 30 031. Alternatively, polydisperse silica gels as described under U.S. Pat. Nos. 3,489,516, 3,656,901 or 2,385,217 may be prepared. By a sizing method, particles within a size range of, in particular, smaller than 5 μm are highly enriched and may then serve as a starting material for the support material according to the invention.

Depending on the ligands with which the base material is to be derivatized, it may be advantageous if the surface of the starting material is already occupied by epoxy groups. Cross-linked polymers consisting of so-called mixed polymers, such as of glycidyl methacrylate and ethylene dimethacrylate, already contain epoxy groups.

However, it is also possible to introduce epoxy groups into starting materials by a procedure known to the skilled person. This may be done, in particular, by reacting a starting material with 3-glycidoxypropylsilane, or by reacting a mixed polymer of, for example, dihydroxypropyl methacrylate and ethylene dimethacrylate, with epichlorohydrin.

Alternative protocols for the preparation of ion-exchange materials based on the reaction of oxirane rings are described in DE 43 33 674 (WO 95/09964) and DE 43 33 821 (WO 95/09695). The skilled person can transfer these procedures to starting materials derivatized with oxirane groups only on the pore surface.

Further synthetic approaches have been described by Pinkerton (EP 0 173 233). Diol-containing base supports are activated with 1,1-carboxydiimidazole (Bethell et al., J. Biol. Chem. 254, 2572, 1979; J. Chrom. 219, 361, 1981) and subsequently reacted with a tripeptide, especially glycine-L-aspartic acid-L-aspartic acid or glycine-L-serine-L-glutamic acid. In a further step, the peptide moiety on the outer surface of the support is hydrolyzed using a peptidase, for example, carboxypeptidase A (exopeptidase acting on the carboxy terminus of a peptide linkage) (Williams et al., FEBS Letters, 54, 353-357, 1975). When a pore diameter of, for example, 4 nm is used, the enzyme cannot penetrate into the pores since it has a molecular weight of 34 Dalton. The selection of a suitable enzyme depends on the nature of the peptide and the size of the pore diameter.

Alternatively, a modification of the method described under U.S. Pat. No. 4,694,092 may be used for the synthesis. The starting materials are support materials of which the outer and pore surfaces are occupied by ion-exchange groups, such as carboxypropyl. By a plasma treatment, the functional groups on the outer surface are converted to silanol groups while the ion-exchange groups on the pore inner surfaces are retained. In another step, the silanol groups are reacted with 3-glycidoxytrimethylsilanes, followed by hydrolyzing the epoxy group with diluted sulfuric acid to obtain a hydrophilic outer surface.

Alternatively, a modification of the preparation method described under EP 0 537 461 may also be used. As the starting material, there are used silica gels modified with diols, which are reacted with fatty acid derivatives to form an ester linkage to yield, for example, carboxylic-acid derivatized silica gels. In a second step, the ester linkages present on the outer surface are hydrolyzed with particle-bound or free esterases and/or lipases.

For example, there may also be used epoxy-containing starting materials which are reacted, as according to DE 43 33 821, to fatty-acid containing ion-exchangers and hydrolyzed with esterases and/or lipases as described above.

According to the invention, it may be desirable to use a support material which has regions on its outer and/or pore surface which contain a functional group in different densities.

It is particularly preferred to use a support material whose pores and/or outer surface have regions derivatized and/or functionalized with alkyl residues having a length of C1 to C50, preferably C4 to C22, more preferably C4, C8 and C18.

It is also advantageous to use a support material whose surface has regions derivatized and/or functionalized with diols.

It is also preferred to use a support material which is modified with glycine on its outer surface and whose pore surface is modified by polypeptides, especially tripeptides.

Also suitable is a support material which is modified with polyethylene glycol and/or polyoxyethylene on its outer surface and whose pore surface is modified with hydrophobic groups, especially phenyl groups and/or C18 and/or C8 and/or nitrile.

Also preferred is the use of a support material which has a substantially spherical design, particularly good separation results being achieved by the use of support materials having an outer diameter, D, of 0.05≦D≦20 μm, preferably 0.1≦D≦5 μm. Thus, for example, support materials having a size of 0.5≦D≦3 μm can be employed.

The outer diameter of the particles can be determined, in particular, with a laser diffraction system, for example, with a Malvern Mastersizer supplied by Malvern Instruments GmbH of Herrenberg, Germany. The principle of laser scattering according to the Mie theory and Fraunhofer analysis is applied. The scattered light is measured. From these scattered light data, the particle size distribution can be derived. Another system for determining the particle size distribution is utilized by the Sedigraph 5100 Particle Sizer supplied by Micrometrics. In this method, the particles to be determined are irradiated with X-rays in a sedimentation solution, and the radiation is detected after having passed the sample. Then, the particle size distribution is determined from the detected radiation.

If the support material has a porous design, it is advantageous for it to have a pore diameter, d, of 0.5≦d≦100 nm, preferably 1≦d≦50 nm, more preferably 2≦d≦6 nm.

The measurement of the pore diameter is preferably effected by using the principle of gas adsorption; for example, apparatus of the company of Beckman Coulter (OMNISORB or SA3100) make use of this principle. Thus, any adsorbed gas is withdrawn from the dry sample under vacuum, and the sample is cooled down to 77 K. At this temperature, inert gases, such as nitrogen, argon or krypton, adsorb to the surface of the particles of the sample. An adsorption isotherm is recorded, i.e., the adsorbed gas volume is plotted against the pressure applied. From these isotherms, the pore size of the particles can be established using the BET (Brunauer, Emmett, Teller) equation. Apparatus for performing such measurements are offered, in particular, by Beckman Coulter.

Comparable results for the pore diameter are achieved by a method according to Walfort (“Chemisch und enzymatisch modifizierte Umkehrphasen-Trägermate-rialien für die HPLC-integrierte Probenaufbereitung”, doctoral thesis, G H Paderborn, 1992), which makes use of the size exclusion chromatographic properties of the support materials. Protein calibration standards of gel permeation chromatography, such as lactate dehydrogenase, ovotransferrin, ovalbumin, carboanhydrase or cytochrome c, having different molecular weights are dissolved in a suitable buffer and injected on columns filled with the support material, and eluted with a suitable buffer or gradient. The composition of the eluate is determined by UV detection. The pore diameter is derived from the molecular weight of the retained molecules.

For the embodiment of a support material having affinity ligands on the pore surface and a hydrophilic outer surface, the above described methods, especially that of Pinkerton (EP 0 173 233), Boss (0 537 461) and Takahata (U.S. Pat. No. 4,694,092), may also be applied. In an exemplary manner, there may be mentioned the reaction of oxirane groups with m-aminophenylboric acid, followed by plasma treatment, hydrophilization of the outer surface with 3-glycidoxytrimethylsilane, and final hydrolysis of the epoxy groups. Another example is the preparation of affinity sorbents containing fatty acids according to DE 43 33 674, followed by hydrolysis of the ester linkages on the outer surface.

For the embodiment of a support material having a hydrophobic pore surface and a hydrophilic outer surface, the method of J. Haginaka et al. (Anal. Chem. 61, 2445-2448, 1989), Pinkerton (U.S. Pat. No. 4,544,485, EP 0 173 233), Boss (0 537 461), Kimata et al. (J. Chromatogr. 515, 73-84, 1990) or Takahata (U.S. Pat. No. 4,694,092) is suitable. In an exemplary manner, there may be mentioned the derivatization of the pore surface with glycine-L-phenylalanine-L-phenylalanine by the method of Pinkerton, or the occupation of the pore inner surface with C-18 groups by the method of Takahata.

For preparing support materials having a hydrophilic pore inner surface and a hydrophobic outer surface, the method of Pinkerton can be modified according to procedures known to the skilled person. The particle surfaces activated with 1,1-carboxydiimidazoles could be reacted, for example, with phenylalanine-L-glycine-L-glycine. After the addition of an enzyme such as carboxypeptidase A, the peptide unit on the outer surface is removed to provide a hydrophobic surface by the derivatization with phenylalanine.

For preparing support materials having a chiral inner surface and a hydrophilic outer surface, a modification of the method of Takahata can be used. A support material covered by oxirane groups is reacted with 6-monodeoxy-6-monoamino-β-cyclodextrin and, in a second step, treated with plasma to remove the chiral ligands on the outer surface.

Preferably, the support material consists of an organic polymer or copolymer containing hydroxy groups.

It is particularly advantageous to use the support material according to the invention in a CEC method for sample processing, wherein the sample consisting of an analyte and other sample components (sample matrix)
is applied to a CEC column system;
an electro-osmotic flow is produced by applying a voltage, whereby the sample molecules are moved and/or the sample molecules migrate according to their charge-to-mass ratio;
the sample matrix is eluted by applying a wash buffer;
the analyte is eluted by applying a transfer buffer.

A “CEC column” within the meaning of the method according to the invention is a support material receiving device which may be designed, in particular, as a capillary column or as a part of a channel system on a chip.

Also preferred is the use according to the invention in a CEC method for the combined sample processing and separation, wherein the sample consisting of an analyte and other sample components
is applied to a CEC column system;
an electro-osmotic flow is produced by applying a voltage, whereby the sample molecules are moved and/or the sample molecules migrate according to their charge-to-mass ratio;
the sample matrix is eluted by applying a wash buffer;
the analyte is separated and eluted by applying an elution buffer.

Stationary phases in CEC columns consisting of support materials having a hydrophilic outer surface, preferably from derivatization with alcohols, and a pore surface modified with ion-exchange groups are particularly suitable for the purification of small charged organic molecules from complex aqueous solutions in CEC. Examples thereof include the purification of charged drugs, such as antisense molecules, from biological body fluids, for example, serum, plasma or urine. Further applications include the purification of plant protective agents from extracts of soil samples or plant parts, or the monitoring of syntheses, such as the labeling of proteins with fluorescent dyes. An alternative application is the use of the ion-exchange materials for the selective increase of the separation rate in CEC, especially at a low pH.

For the purification of anionic antisense oligonucleotides from serum using methods of CEC, it is advantageous to use those support materials as the stationary phase in CEC which are characterized by a hydrophilic outer surface, preferably from derivatization with alcohols, and have a pore surface which is derivatized with anion-exchangers, preferably —NR₃⁺⁻OH, with R=ethyl, propyl.

A support material having affinity ligands such as borate groups on the pore surface and a hydrophilic outer surface is particularly suitable for the separation of compounds containing hydrocarbons, such as the monitoring of the enzymatic reaction of phosphorylases with polysugars such as (glucose)ₙ.

Further applications of the support materials include the separation of drugs, such as hydrocortisone, from serum or plasma. It is particularly preferred here to use support materials which are functionalized with hydrocortisone-specific Fab fragments on the pore surface and whose outer surface is hydrophilized, for example, by diol groups. The hydrophilic outer surface prevents the absorption of the sample components in aqueous solutions. This method is suitable, in particular, for complex samples with a very large number of components, such as serum and plasma.

For the purification of small hydrophilic molecules by the CEC method according to the invention from, for example, organic extracts of creams or the isolation of water-soluble vitamins from margarine, a support material covered by alcohol groups on the pore inner surface and phenyl groups on the pore outer surface is used as the stationary phase.

The separation of the reaction product from synthetic mixtures containing hydrophilic polymers, especially polyethylene glycol and hydrophilic reactants, such as oligonucleotides, can preferably be effected by using support materials as the stationary phase which have the following properties: Their pore surface is derivatized with diols or sugars. Their outer surface has hydrophobic properties from derivatization with C8 alkyl residues.

For the separation of mixtures of enantiomers, such as temazepam or warfarine, in biological fluids, a support material having a hydrophilic outer surface and a chiral pore inner surface is suitable. For example, the support can be covered with alcohols on its outer surface and with cyclodextrins on the pore inner surface. The chiral ligand 1,2-diphenylethyldiamine is particularly suitable for the separation of aryl carbinols.

For the purification of small cationic molecules from Hengst buffered saline solution (HBSS), such as atenolol, a support material covered by carboxylic acid groups on the pore inner surface and diol groups on the pore outer surface is used as the stationary phase. The column is preferably equilibrated with an aqueous buffer at a pH of greater than 6, followed by applying the sample to the column and removing the HBSS components by applying an electric field. For the efficient separation and detection of atenolol, a change is made to a buffer having a pH of smaller than 3, and the separation effected by applying an electric field.

Particularly good separation results are obtained when the composition of the mobile phase is individually adapted to the support material. In particular, it may be desirable to generate many charged ion-exchange molecules by selecting the pH value, or to minimize the charge with a pH value which particularly favors the protonation of the ion-exchange molecules. An aqueous buffer may be used, but it may also be preferred to equilibrate the CEC column with an organic buffer, for example, 95% acetonitrile in water, for example, in the presence of ammonium acetate, pH 4.7. In addition, it may be preferred to use a different buffer for applying the sample to the CEC column from that used for the separation and detection of the analyte.

For the purification of vitamin C from liquid cream, for example, a support material is suitable which is covered by C-8 on the outer surface and with diol on the pore surface. The column is equilibrated with a buffer which contains, for example, more than 90% acetonitriles. The sample is applied, and the hydrophobic components are removed by applying an electric field. For the efficient separation and detection, a change is made to a buffer containing more than 60% aqueous phase, and the separation is effected by applying an electric field. The separation can be optimized by adjusting the hydrophobicity of the mobile phase.

For the separation of hydrocortisone from serum, a support material covered by hydrocortisone-specific Fab fragments on the pore inner surface and by alcohols on the pore outer surface is particularly suitable. For example, the Fab fragment is selected such that the binding and elution of the antigen can be performed at two different pH values. The binding is effected, for example, at a pH of below 6 in aqueous buffer so that the serum components are removed by applying an electric field. The elution and detection is performed after applying a buffer of pH greater than 7.5 and applying an electric field.

The mobile phase is preferably comprised of buffer salts in the presence of anionic and/or cationic and/or zwitterionic ion-pair reagents. Its composition can be directly adapted to the nature and properties of the analyte to obtain a good separating performance, as demonstrated by the Examples. However, when the composition of the analyte is unknown, it is also possible to employ so-called universal buffers which have been optimized for the separation and elution of analytes having an unknown composition.

To achieve particularly good separation results, it is also desirable for the washing buffer and elution buffer to contain organic solvents. The washing buffer should contain at least 1% of organic solvent, and the elution buffer should contain at least 20% thereof.

All in all, in a particularly preferred form of the method, the stationary and mobile phases should be selected such that the electro-osmotic flow respectively remains constant during the binding and elution of the analyte, or changes in a reproducible way, an electro-osmotic flow within a range of from 0.5 to 10 mm/s being preferred. To produce the electro-osmotic flow, a high direct voltage is preferably employed.

The application of the sample to the column and the quantitative removal of the matrix is preferably performed hydrodynamically and/or electro-osmotically and/or electrophoretically, which results in a concentration of the analyte by a factor of from 10 to 1000.

However, it may also be preferred to apply the sample to the column and wash it in a flash-back method. This reduces a possible contamination of the column with matrix components and also results in concentration of the sample at the top of the column.

It is also advantageous to perform the elution and separation of the analytes hydrodynamically and/or electro-osmotically and/or electrophoretically.

Particularly preferred is the electro-osmotic elution and separation of the analytes in order to obtain a sufficient plate number even when very short columns, preferably of ≦10 cm, are used.

In another embodiment, a further concentration of the analyte by a factor of from 10 to 1000 is achieved by isotachophoresis during the elution. Thus, for example, the analyte can be transferred from a separate sample processing column to a separating column without a substantial change in volume.

For increasing the selectivity of the method and/or for increasing the electro-osmotic flow, mixtures of different support materials are preferably employed as the stationary phase. A particular advantage of such mixtures is their permitting optimum adaptation to the properties of the mobile phase and the sample and thus ensuring a sensitive and selective separation.

If a detection of the analytes is to be effected subsequent to the separation and elution, it is desirable, especially in mass-spectroscopic detection, for the buffer salts and/or anionic and/or cationic and/or zwitterionic ion-pair reagents to be volatile at room temperature.

For an accurate characterization of the composition of the analyte, both qualitatively and quantitatively, it is possible, in a preferred embodiment, to perform various spectrometric and spectroscopic analytical methods subsequent to the separation and/or elution. Of particular advantage are the methods of mass spectrometry and/or optical detection, for example, by light scattering, especially condensation nucleation light scattering detection (Szostek et al., 1997, Analytical Chemistry, 69, 2955-2962), and/or fluorescence detection, and/or electrochemical detection, and/or conductivity detection, and/or refractive index detection, especially laser-based refractive index detection coupled with absorption detection (Anal Chem. 59, 1632-1636, 1987) and/or laser-based refractive index detection using backscatter (U.S. Pat. No. 5,325,170), and/or chemiluminescence nitrogen-specific detection (LC-GC 12, 5, 287-293, 1999), and/or thermo-optical detection, especially thermo-optical absorption detection (Anal. Chem. 61, 37-40, 1989), and/or laser-induced capillary vibration (Anal. Chem. 63, 2216-2218, 1991). Thus, for example, UV detection is employed in Example 1. The components of the analyte can be collected in a fractionated manner after the separation

However, it may also be preferred to supply the analyte fractions to a fraction collector subsequent to the separation, i.e., collect them individually to be passed to a further use.

In another embodiment, transfer to another column system may also be desirable for further separation. In particular, after elution, the analyte can be transferred to a high pressure liquid chromatography device, capillary electrophoresis device or liquid chromatography device.

Of particular advantage is the possibility of a parallel operation of the method in a multitude of interconnected CEC column systems.

According to the invention, a CEC device preferably contains the following components:

A support material receiving unit with at least one inlet and at least one outlet, packed with support material which has a porous design and whose surface consists of an outer surface and a pore surface, wherein the outer surface has regions of different derivatization and/or functionality from that of the pore surface;

at least two vessels for receiving the mobile phase; and

at least one voltage source.

Particularly preferred is a CEC device in which pressure generating means is additionally provided for applying pressure to the support material receiving unit.

It is also preferred to provide a system for the automatic changing of the vessels for receiving the mobile phase.

In addition, it is advantageous to couple the support material receiving unit to at least one detector, which detector is preferably designed as a mass spectrometer and/or optical detector, especially UV detector, light-scattering detector, more preferably condensation nucleation light scattering detector and/or fluorescence detector and/or electrochemical detector and/or conductivity detector and/or refractive index detector, especially laser-based refractive index detector coupled with absorption detection, and/or laser-based refractive index detector using backscatter, and/or chemiluminescence nitrogen-specific detector, and/or thermo-optical detector, especially thermo-optical absorption detector, and/or laser-induced capillary vibration detector.

In another embodiment of the device according to the invention, the support material receiving unit is designed as a capillary column.

It is also preferred that the support material receiving unit of the device according to the invention is designed as a part of a channel system on a chip.

Further, it is advantageous that the capillary column and the chip consist of plastics and/or glass and/or fused silica and/or ceramics and/or elastomer and/or polymers.

In another embodiment of the device according to the invention, at least two support material receiving units are provided which are interconnected through a capillary system and/or a channel system, said channel system and/or capillary system preferably having at least one outlet.

In addition, in a preferred embodiment, it is advantageous for the outlet of the support material receiving unit to have an inner and/or outer diameter which is different from that of the inlet.

It is particularly advantageous when the outlet is designed as an electrospray device.

In another embodiment, a multitude, especially from 2 to 50, more preferably from 2 to 16, support material receiving units are provided in a parallel and/or two-dimensional arrangement.

It is also preferred for said at least one support material receiving unit of the device according to the invention to contain a mixture of different kinds of support materials, each kind of support material having a porous design and a surface which consists of an outer and a pore surface, wherein the outer surface has regions of different derivatization and/or functionality from that of the pore surface.

In another preferred embodiment of the device, the sample receiving means is designed to receive samples having a volume, V, of 0.5 nl≦V≦100 μl. It is of particular advantage to use CEC columns having a length of from 0.1 to 100 cm and a diameter of ≦500 μm.

A “CEC column” within the meaning of the device according to the invention means a support material receiving unit which may be designed, in particular, as a capillary column or part of a channel system on a chip.

Embodiments of the device are explained below with reference to the enclosed Figures.

FIG. 1 shows a CEC column system which consists of a single column for the sample processing and/or separation.

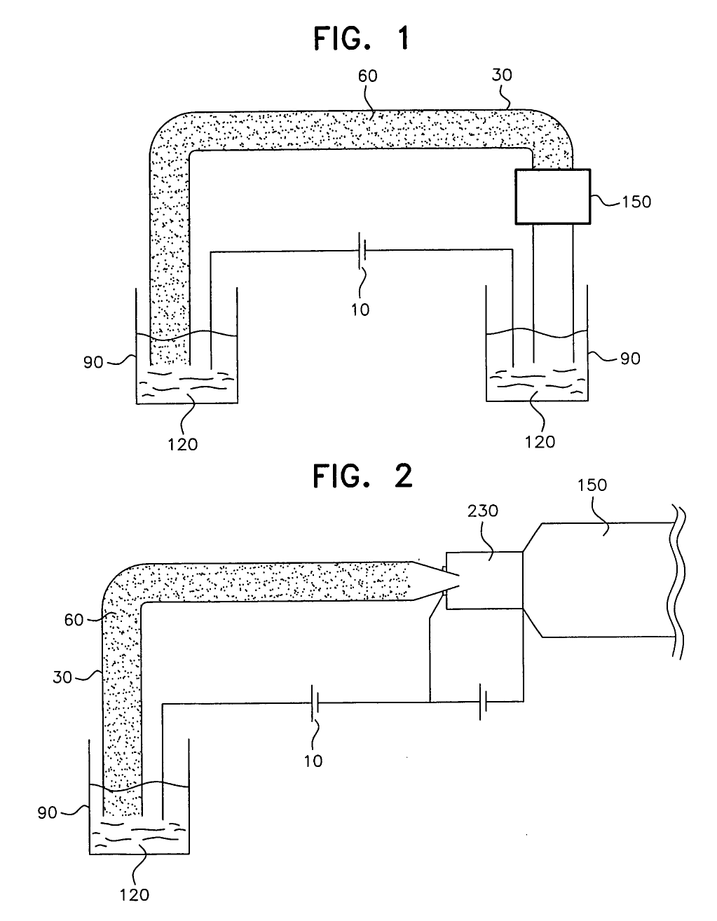

FIG. 2 shows the coupling of a CEC column system to a detector, in this case a mass spectrometer.

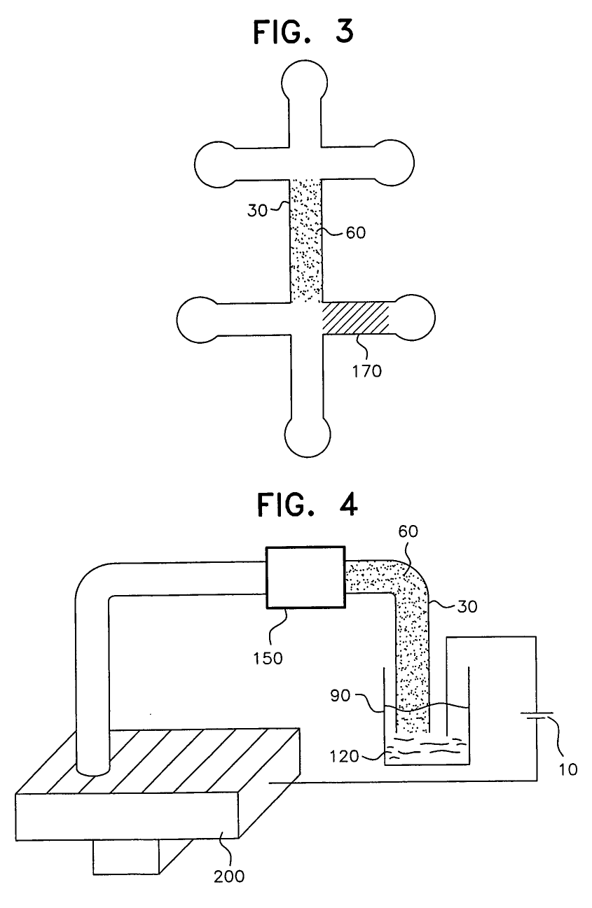

FIG. 3 shows the coupling of a CEC column system to another column.

FIG. 4 shows the coupling of a CEC column system to a fraction collector.

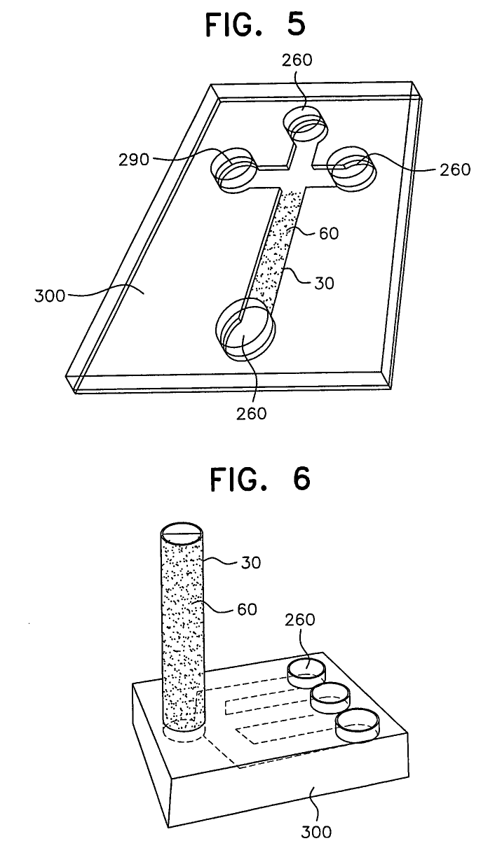

FIG. 5 shows a CEC chip system.

FIG. 6 shows a possible embodiment of a CEC chip system which is coupled to a capillary system.

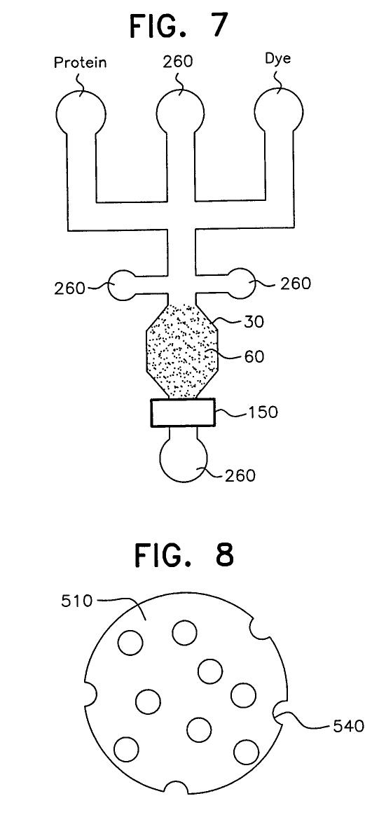

FIG. 7 shows in an illustrative way a possible embodiment of a μ-total analysis system.

FIG. 8 shows in an illustrative way a particle of a porous support material.

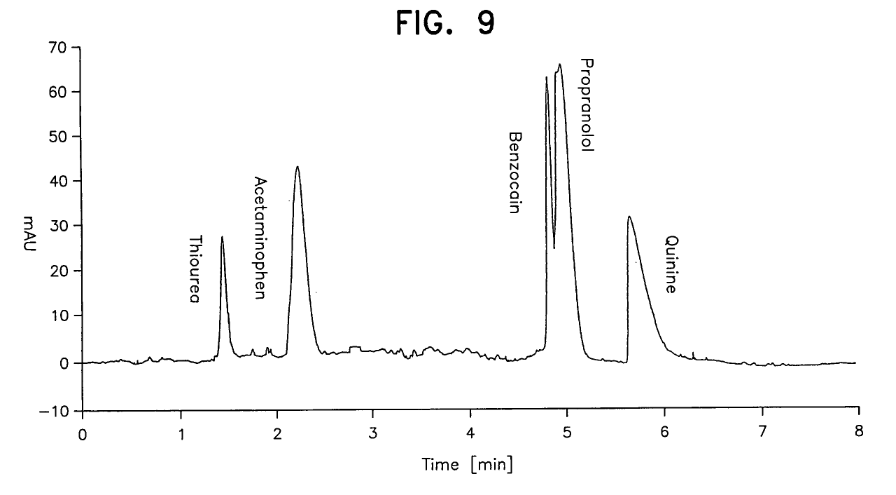

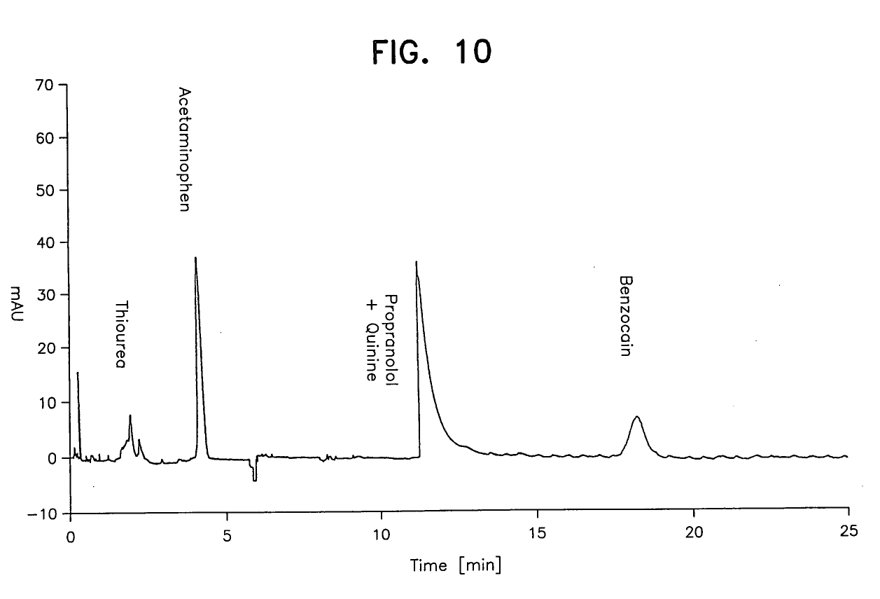

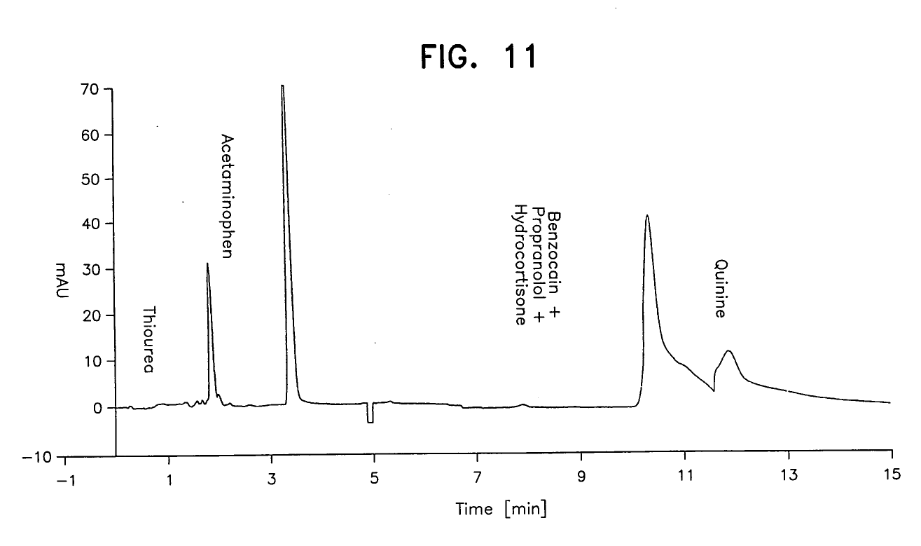

FIG. 9 shows the electropherogram of an analyte mixture, separated on a CEC column packed with ISPR GFFII-S5-80.

FIG. 10 shows the electropherogram of an analyte mixture, separated on a CEC column packed with SPS 5PM-S5-100-phenyl.

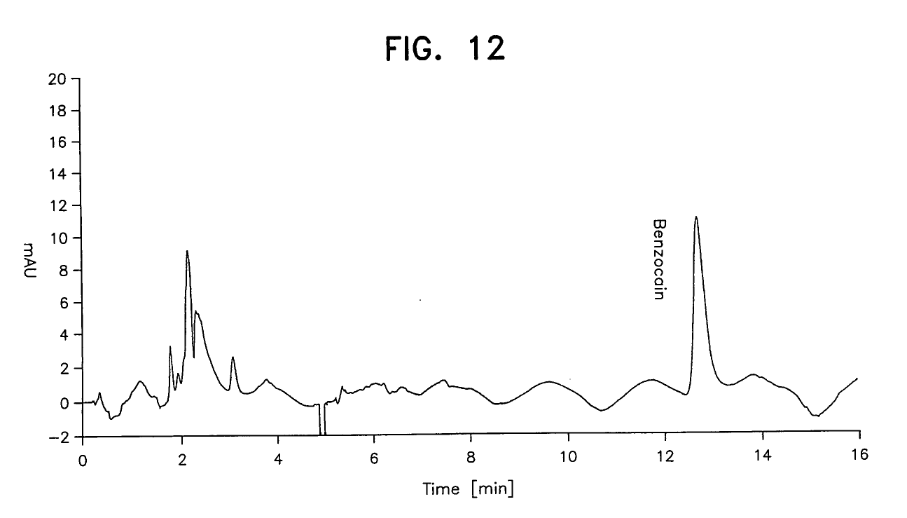

FIG. 11 shows the electropherogram of an analyte mixture, separated on a CEC column packed with SPS 5PM-S5-100-CN.

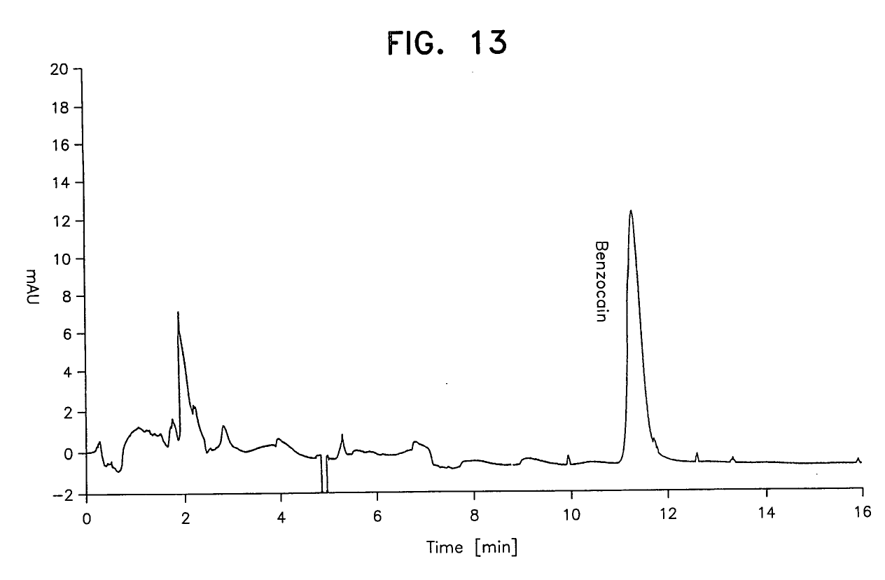

FIG. 12 shows the electropherogram of benzocain from pure rat serum, separated on a CEC column packed with SPS 5PM-S5-100-CN.

FIG. 13 shows the electropherogram of benzocain from pure dog plasma, separated on a CEC column packed with SPS 5PM-S5-100-CN.

A particularly advantageous embodiment of the device is represented in FIG. 1. A CEC column (30) packed with the support material (60) according to the invention is immersed with both ends in the container (90) with the mobile phase (120). The voltage source (10) serves for applying a voltage between the two ends of the columns. The voltage enables the build-up of an electro-osmotic flow in the column. In addition, a device for applying pressure to the containers may also be provided. The applying of pressure uniformly to both ends of the column counteracts the degassing of the buffer solutions and thus the formation of air bubbles in the column. One column end is designed for taking up the sample. A changing device enables the changing of the containers (90) and thus the changing or adaptation of the buffer solutions (120) to the process step. By applying, for example, a detector (150) as outlined in FIG. 1 directly on the column, the analyte can be directly detected and analyzed.

In a further embodiment of the device, it is preferred that the column system consist of at least one CEC column for sample processing and at least one CEC column for separation of the analyte which are interconnected through a capillary system, wherein this capillary system, in a particularly preferred embodiment, has at least one outlet through which the sample matrix can be removed.

In addition, it is also possible to use a CEC column (30) only for sample processing. A possible embodiment thereof is represented in FIG. 3. This example shows the combination of a CEC column (30) with another column (170) arranged on a chip. It is also possible to transfer the analyte to other analytical or separating systems after separating off the sample matrix.

The device may also comprise a coupling of the column system to at least one detector, especially mass spectrometer and/or light-scattering detector or other optical detector, and/or electrochemical detector, and/or fluorescence detector, and/or conductivity detector, and/or refractive index detector, especially laser-based refractive index detector coupled with absorption detection, and/or laser-based refractive index detector using backscatter, and/or chemiluminescence nitrogen-specific detector, and/or thermo-optical detector, especially thermo-optical absorption detector, and/or laser-induced capillary vibration detector (150). This preferred embodiment is outlined in FIG. 2 with coupling to a mass spectrometer which comprises an electrospray device (230). For coupling to a detector, it may be preferred for the outlet of the column system to have an inner and/or outer diameter which is different from that of the inlet.

In addition, in another preferred embodiment of the device, it is provided that the column system (30) may be coupled to a fraction collector and/or another column system. This may be effected, for example, by direct coupling. In a preferred embodiment (FIG. 4), for fraction collection, a voltage is applied between the inlet of the column and, for example, a gold-coated MALDI plate (200) (Meeting Abstract, Advances in Mass Spectrometry, Jan. 7-8, 1999, Orlando, Fla., USA). The eluate is atomized, and the analyte is selectively collected in individual wells of the plate.

In another advantageous embodiment, the CEC column system is arranged on a chip (300) (FIG. 5). A column system is represented which consists of a support material receiving unit (30) with a support material (60) according to the invention, a sample reservoir (290) and three buffer reservoirs (260). The system is designed in such a way that each reservoir can accommodate one electrode. Thus, a voltage can be selectively applied between different reservoirs. In a preferred embodiment, the addressing and switching of the electrodes is effected automatically, wherein the exact circuit diagrams can be managed by computer programs.

In a particularly advantageous embodiment, the chip system (300) is combined with glass capillaries or CEC columns (30) made of fused silica. An example of this embodiment of the device according to the invention is outlined in FIG. 6.

For preparing the capillaries and chip systems, it is preferred to use materials such as plastics, glass, fused silica, ceramics, elastomers or polymers.

The preparation of suitable chips can be effected, for example, by applying photolithography in connection with etching techniques. This has been described, for example, by J. P. Landers (Handbook of Capillary Electrophoresis, 1997, CRC Press, page 828) for the preparation of chips for use in capillary electrophoresis. Materials such as glass or fused silica are coated with a photosensitive substance. The desired channel system is transferred to the substrate by exposure to light using a mask and etched into the substrate, for example, in a bath of diluted HF/NH₄F. For substrates of fused silica, it is necessary to apply a gold/chromium thin film to the substrate as an etching mask.

Depending on the material employed for the preparation of the capillaries or support material receiving units for the CEC columns and chip systems, it may be desirable to coat the capillary interior surface to prevent non-specific reactions of the sample with, for example, free silanol groups thereon. This is advantageously effected with PVA or polyacrylamide.

In another particular embodiment of the device, the column system is a component of a total analysis system.

A possible total analysis system is represented in FIG. 7. Such a system represents the entirety of an analytical system and can equally comprise the sample processing and analysis and optionally upstream and/or downstream steps. The μTAS represented in FIG. 7 comprises the labeling of a protein with a dye, the separation of the dye and of the unlabeled protein through a CEC column (30) packed with the support material (60) according to the invention, and the detection of the labeled protein. The system outlined here can be integrated, for example, on a chip, the round recesses being capable of respectively accommodating electrodes for applying a voltage.

Another embodiment provides for the parallel operation of a multitude of CEC column systems in which the sample processing and separation is performed in parallel. These column systems are chip systems or capillary systems or combinations of both. Such a coupling of several systems is advantageous, in particular, in high-throughput screening since it allows the parallel processing and separation of a multitude of samples, which can then be further examined.

FIG. 8 shows in an illustrative way a particle of a porous support material. The surface of this support material can be subdivided into an outer surface (510) and a pore surface (540).

FIG. 9 shows the electropherogram of an analyte mixture in a model matrix. The performance was effected with a CEC column filled with ISPR GFFII-S5-80 (pore size 8 nm). Length of the packed capillary: 8.3 cm. Inner diameter: 100 μm. Detection wavelength: 210 nm. Further conditions, see Example 1.

FIG. 10 shows the electropherogram of an analyte mixture in a model matrix. The performance was effected with a CEC column filled with SPS 5PM-S5-100-phenyl (pore size 10 nm). Length of the packed capillary: 8.3 cm. Inner diameter: 100 μm. Detection wavelength: 210 nm. Further conditions, see Example 2.

FIG. 11 shows the electropherogram of an analyte mixture in a model matrix. The performance was effected with a CEC column filled with SPS 5PM-S5-100-CN (pore size 10 nm). Length of the packed capillary: 8.3 cm. Inner diameter: 100 μm. Detection wavelength: 210 nm. Further conditions, see Example 3.

FIG. 12 shows the electropherogram of benzocain from pure rat serum. The performance was effected with a CEC column filled with SPS 5PM-S5-100-CN supplied by Regis® (pore size 10 nm). Length of the packed capillary: 8.3 cm. Inner diameter: 100 μm. Detection wavelength: 210 nm. Further conditions, see Example 4.

FIG. 13 shows the electropherogram of benzocain from pure dog plasma. The performance was effected with a CEC column filled with SPS 5PM-S5-100-CN supplied by Regis® (pore size 10 nm). Length of the packed capillary: 8.3 cm. Inner diameter: 100 μm. Detection wavelength: 210 nm. Further conditions, see Example 5.

### EXAMPLE 1

### Separation of a Mixture of Analytes in a Model Matrix on a CEC Column Packed with ISRP GFFII-S5-80

### Materials Employed:

The CEC column having a length of 8.3 cm and an inner diameter of 100 μm was packed with Pinkerton ISRP GFFII-S5-80 supplied by Regis® Technologies, Inc., Austin, USA. The particles employed had a diameter of 5 μm and a pore size of 8 nm.

The washing buffer consisted of 50% acetonitrile, 95% water, 5 mM ammonium acetate (pH 8.5). The elution buffer consisted of 40% acetonitrile, 60% water, 5 mM ammonium acetate (pH 8.5).

The solution contained FBS (fetal bovine serum) in a concentration of 10 mg/ml, and 1 mg/ml each of thiourea, acetaminophen, benzocain, propranolol and quinine. In the following, this sample solution is referred to as “mixture of analytes in a model matrix”.

### Device

For performing the separation of the mixture of analytes in a model matrix, the device shown in FIG. 1 was employed. The column packed with ISRP GFFII-S5-80 was immersed with its ends each in a container for receiving buffer solution. Using a voltage source (10), a voltage was applied between the two ends of the column.

### Column Preparation

The column preparation was performed at 15° C. in 2 steps:

The column was first equilibrated with separating buffer. During this process, the voltage was increased stepwise in steps of −5 kV up to −20 kV at intervals of 5 min while a pressure of 5 bar was applied to the inlet buffer container (buffer container into which the inlet of the column is immersed). Then, a pressure of 10 bar was applied to both containers, and a voltage of −15 kV was applied. The stability of the column was monitored in the meantime by measuring the current and the UV absorption (210 nm).

The 2nd equilibration phase was performed in washing buffer and took 12 min, a voltage of −15 kV and a pressure of 10 bar being applied to both buffer containers. The current and the voltage were also monitored.

After the end of the 2nd phase, the current and UV absorption were stable.

### Separations

During the whole operation, the temperature of the buffers, the samples and the separating capillary was controlled to 15° C.

The sample (mixture of analytes in a model matrix) was electrokinetically charged onto the column by applying a voltage of −5 kV for 3 seconds. Subsequently, a small amount of washing buffer, a so-called buffer plug, was charged onto the column under the same conditions in order to prevent the possible diffusion of the sample into the buffer container.

Subsequently, the sample was washed by applying the washing buffer at a voltage of −15 kV and applying a pressure of 10 bar to both ends of the column to remove the proteins and salts of the model matrix from the CEC column. After 3 minutes, the washing buffer was replaced by an elution buffer. The conditions of −15 kV and 10 bar were retained. Thiourea eluted at 1.48 min, acetaminophen at 2.27 min, benzocain at 4.88 min, propranolol at 4.99 min, and quinine at 5.67 min. The electropherogram of this separation is shown in FIG. 9.

### EXAMPLE 2

### Separation of a Mixture of Analytes in a Model Matrix on a CEC Column Packed with SPS 5PM-S5-100-phenyl

### Materials Employed:

The CEC column having a length of 8.3 cm and an inner diameter of 100 μm was packed with SPS 5PM-S5-100-phenyl supplied by Regis® Technologies, Inc., Austin, USA. The particles employed had a diameter of 5 μm and a pore size of 10 nm.

The washing buffer consisted of 5% acetonitrile, 95% water, 5 mM ammonium acetate (pH 4.7). The elution buffer consisted of 15% acetonitrile, 85% water, 5 mM ammonium acetate (pH 4.7).

The solution contained FBS (fetal bovine serum) in a concentration of 10 mg/ml, and 1 mg/ml each of thiourea, acetaminophen, benzocain, propranolol and quinine. In the following, this sample solution is referred to as “mixture of analytes in a model matrix”.

### Device

For performing the separation of the mixture of analytes in a model matrix, the device shown in FIG. 1 was employed. The column packed with SPS 5PM-S5-100-phenyl was immersed with its ends each in a container for receiving buffer solution. Using a voltage source (10), a voltage was applied between the two ends of the column.

### Column Preparation

The column preparation was performed in accordance with Example 1.

### Separations

During the whole operation, the temperature of the buffers, the samples and the separating capillary was controlled to 15° C.

The sample (mixture of analytes in a model matrix) was electrokinetically charged onto the column by applying a voltage of −5 kV for 3 seconds. Subsequently, a small amount of washing buffer, a so-called buffer plug, was charged onto the column under the same conditions in order to prevent the possible diffusion of the sample into the buffer container.

Subsequently, the sample was washed by applying the washing buffer at a voltage of −15 kV and applying a pressure of 10 bar to both ends of the column to remove the proteins and salts of the model matrix. After 6 minutes, the washing buffer was replaced by an elution buffer. The conditions of −15 kV and 10 bar were retained. Thiourea eluted at 1.94 min, acetaminophen at 4.23 min, propranolol and quinine at 11.34 min, and benzocain at 18.25 min. The electropherogram of this separation is shown in FIG. 10.

### EXAMPLE 3

### Separation of a Mixture of Analytes in a Model Matrix on a CEC Column Packed with SPS 5PM-55-100-CN

### Materials Employed:

The CEC column having a length of 8.3 cm and an inner diameter of 100 μm was packed with SPS 5PM-55-100-CN supplied by Regis® Technologies, Inc., Austin, USA. The particles employed had a diameter of 5 μm and a pore size of 10 nm.

The washing buffer consisted of 5% acetonitrile, 95% water, 5 mM ammonium acetate, pH 4.7. The elution buffer consisted of 15% acetonitrile, 85% water, 5 mM ammonium acetate, pH 4.7.

The solution contained FBS (fetal bovine serum) in a concentration of 10 mg/ml, and 1 mg/ml each of thiourea, acetaminophen, benzocain, propranolol and quinine. In the following, this sample solution is referred to as “mixture of analytes in a model matrix”.

### Device

For performing the separation of the mixture of analytes in a model matrix, the device shown in FIG. 1 was employed. The column packed with SPS 5PM-S5-100-CN was immersed with its ends each in a container for receiving buffer solution. Using a voltage source (10), a voltage was applied between the two ends of the column.

### Column Preparation

The column preparation was performed in accordance with Example 1.

### Separations

During the whole operation, the temperature of the buffers, the samples and the separating capillary was controlled to 15° C.

The sample (mixture of analytes in a model matrix) was electrokinetically charged onto the column by applying a voltage of −5 kV for 3 seconds. Subsequently, a small amount of washing buffer, a so-called buffer plug, was charged onto the column under the same conditions in order to prevent the possible diffusion of the sample into the buffer container.

Subsequently, the sample was washed by applying the washing buffer at a voltage of −15 kV and applying a pressure of 10 bar to both ends of the column to remove the proteins and salts of the model matrix. After 5 minutes, the washing buffer was replaced by an elution buffer. The conditions of −15 kV and 10 bar were retained. Thiourea eluted at 1.87 min, acetaminophen at 3.43 min, benzocain, propranolol and hydrocortisone at 10.39 min, and quinine at 11.87 min. The electropherogram of this separation is shown in FIG. 11.

### EXAMPLE 4

### Separation of Benzocain in Rat Serum

### Materials Employed:

The CEC column having a length of 8.3 cm and an inner diameter of 100 μm was packed with SPS 5PM-S5-100-CN supplied by Regis® Technologies, Inc., Austin, USA. The particles employed had a diameter of 5 μm and a pore size of 10 nm.

The washing buffer consisted of 5% acetonitrile, 95% water, 5 mM ammonium acetate, pH 4.7. The elution buffer consisted of 15% acetonitrile, 85% water, 5 mM ammonium acetate, pH 4.7.

The sample consisted of rat serum doped with benzocain in a concentration of 0.5 mg/ml of serum.

### Device

The device corresponded to that of Example 3.

### Column Preparation

The column preparation was performed in accordance with Example 3.

### Separations

During the whole operation, the temperature of the buffers, the samples and the separating capillary was controlled to 15° C.

The sample was electrokinetically charged onto the column by applying a voltage of −5 kV for 3 seconds. Subsequently, a small amount of washing buffer, a so-called buffer plug, was charged onto the column under the same conditions in order to prevent the possible diffusion of the sample into the buffer container.

Subsequently, the sample was washed by applying the washing buffer at a voltage of −15 kV and applying a pressure of 10 bar to both ends of the column to remove the proteins and salts of the model matrix. After 5 minutes, the washing buffer was replaced by an elution buffer. The conditions of −15 kV and 10 bar were retained. The benzocain eluted at 12.75 min. The electropherogram of this separation is shown in FIG. 12.

### EXAMPLE 5

### Separation of Benzocain in Dog Plasma

### Materials Employed:

The CEC column having a length of 8.3 cm and an inner diameter of 100 μm was packed with SPS 5PM-S5-100-CN supplied by Regis® Technologies, Inc., Austin, USA. The particles employed had a diameter of 5 μm and a pore size of 10 nm.

The washing buffer consisted of 5% acetonitrile, 95% water, 5 mM ammonium acetate, pH 4.7. The elution buffer consisted of 15% acetonitrile, 85% water, 5 mM ammonium acetate, pH 4.7.

The sample consisted of dog plasma doped with benzocain in a concentration of 0.5 mg/ml of plasma.

### Device

The device corresponded to that of Example 3.

### Column Preparation

The column preparation was performed in accordance with Example 3.

### Separations

During the whole operation, the temperature of the buffers, the samples and the separating capillary was controlled to 15° C.

The sample was electrokinetically charged onto the column by applying a voltage of −5 kV for 3 seconds. Subsequently, a small amount of washing buffer, a so-called buffer plug, was charged onto the column under the same conditions in order to prevent the possible diffusion of the sample into the buffer container.

Subsequently, the sample was washed by applying the washing buffer at a voltage of −15 kV and applying a pressure of 10 bar to both ends of the column to remove the proteins and salts of the model matrix. After 5 minutes, the washing buffer was replaced by an elution buffer. The conditions of −15 kV and 10 bar were retained. The benzocain eluted at 11.38 min. The electropherogram of this separation is shown in FIG. 13.

1-36. (canceled)

37. A device for capillary electrochromatography (CEC) comprising:
a support material receiving unit (30) having at least one inlet and at least one outlet, packed with
porous support material (60) having an outer surface (510) and a pore surface (540), wherein the outer surface has regions of different derivatization and/or functionality from that of the pore surface.

38. The device according to claim 37, characterized in that said support material receiving unit is a capillary column.

39. The device according to claim 38, characterized in that said support material receiving unit is designed as a part of a channel system on a chip.

40. The device according to claim 37, characterized in that at least two vessels (90) for receiving the mobile phase (120) and at least one voltage source (10) are provided.

41. The device according to claim 37, characterized in that a pressure generating means is provided for applying pressure to the support material receiving unit.

42. The device according to claim 37, characterized in that a system is provided for the automatic changing of the vessels for receiving the mobile phase.

43. The device according to claim 37, characterized in that said support material receiving unit is coupled to at least one detector (150).

44. The device according to claim 43, characterized in that said detector is designed as a mass spectrometer and/or optical detector, especially light-scattering detector, UV detector, and/or electrochemical detector, and/or fluorescence detector, and/or conductivity detector, and/or refractive index detector, especially laser-bound refractive index detector coupled with absorption detection, and/or laser-based refractive index detector using backscatter, and/or chemiluminescence nitrogen-specific detector, and/or thermo-optical detector, especially thermo-optical absorption detector, and/or laser-induced capillary vibration detector.

45. The device according to claim 43, characterized in that said detector is a condensation nucleation light scattering detector.

46. The device according to claim 39, characterized in that said capillary column and chip consist of plastics and/or glass and/or fused silica and/or ceramics and/or elastomer and/or polymers.

47. The device according to claim 37, characterized in that at least two support material receiving units are provided which are interconnected through a capillary system and/or channel system.

48. The device according to claim 47, characterized in that said channel system and/or capillary system has at least one outlet.

49. The device according to claim 37, characterized in that the outlet of the support material receiving unit has an inner and/or outer diameter which is different from that of the inlet.

50. The device according to claim 43, characterized in that said outlet is designed as an electrospray device.

51. The device according to claim 43, characterized in that a multitude, especially from 2 to 50, more preferably from 2 to 16, support material receiving units are provided in a parallel and/or two-dimensional arrangement.

52. The device according to claim 43, characterized in that said at least one support material receiving unit contains a mixture of different kinds of support materials, each kind of support material having a porous design and a surface which consists of an outer and a pore surface, wherein the outer surface has regions of different derivatization and/or functionality from that of the pore surface.

53. In a method of capillary-electrochromatographic processing comprising applying a sample to a support material, the improvement wherein the support material is a porous support material having an outer surface (510) and a pore surface (540), characterized in that the outer surface has regions of different derivatizations and/or functionality from that of the pore surface.

54. The method according to claim 53, characterized in that said regions of different derivatization and/or functionality are distributed on said outer and/or pore surfaces homogeneously and/or heterogeneously.

55. The method according to claim 53, characterized in that said pore and/or outer surface is derivatized and/or functionalized with hydrophobic and/or hydrophillic groups and/or ion-exchange groups and/or affinity ligands and/or chiral groups.

56. The method according to claim 53, characterized in that said pore and/or outer surface comprises regions derivatized and/or functionalized with alkyl residues having a length of C₁ to C₅₀, preferably C₄ to C₂₂, more preferably C₄, C₈ and C₁₈.

57. The method according to claim 53, characterized in that said pore and/or outer surface comprises regions derivatized and/or functionalized with diols.

58. The method according to claim 53, characterized in that said support material has a substantially spherical design having an outer diameter, D, of 0.05≦D≦20 μm, preferably 0.1≦D≦5 μm, more preferably 0.5≦D≦3 μm.

59. The method according to claim 53, the support material being characterized by having a pore diameter, d, of 0.5≦d 100 nm, preferably 1≦d≦50 nm, more preferably 2≦d≦6 nm.

60. The method according to claim 53, the support material being characterized by consisting of an organic polymer or copolymer containing hydroxy groups.

61. The method according to claim 53, the support material being characterized by consisting of a silicate-containing material modified with polyethylene glycol or polyoxyethylene on its outer surface, and in that the pore surface is modified with hydrophobic groups, especially phenyl groups, C₁₈, C₈ and/or nitrile.

62. The method according to claim 53, the support material being characterized by consisting of a hydroxy-containing material modified with glycine on its outer surface and modified with polypeptides, especially tripeptides, on the pore surface.

63. The method according to claim 53, the support material being characterized by consisting of a silica gel modified with glycerolpropyl.

64. The method according to claim 53, the support material being characterized by consisting of glass modified with glycerolpropyl.

65. The method according to claim 53, the support material being characterized by comprising the following steps:
applying a sample consisting of an analyte and sample matrix to a capillary electrochromatography (CEC) device comprising:
a support material receiving unit (30) having at least one inlet and at least one outlet, packed with
porous support material (60) having an outer surface (510) and a pore surface (540), wherein the outer surface has regions of different derivatization and/or functionality from that of the pore surface;
applying a voltage to produce an electro-osmotic flow;
applying a wash buffer;
eluting the sample matrix;
applying a transfer buffer;
eluting the analyte.

66. The method according to claim 65, characterized in that the following steps are performed after the elution of the sample matrix;
applying an elution buffer;
separation and eluting the analyte.

67. The method according to claim 66, characterized in that, after the analyte, has been separated, its components and/or the concentration of its components are determined by a detector.

68. The method according to claim 67, characterized in that said detector is a mass spectrometer and/or optical detector, especially light-scattering detector, condensation nucleation light scattering detector, and/or electrochemical detector, and/or conductivity detector, and/or refractive index detector, especially laser-based refractive index detector coupled with absorption detection, and/or laser-based refractive index detector using backscatter, and/or chemiluminescence nitrogen-specific detector, and/or thermo-optical detector, especially thermo-optical absorption detector, and/or laser-induced capillary vibration detector.

69. The method according to claim 65, characterized in that the application of the sample to the CEC device is performed hydrodynamically and/or electro-osmotically and/or electrophoretically.

70. The method according to claim 66, characterized in that components of the analyte are collected in a fractionated manner after the separation.

71. The method according to claim 65, characterized in that the analyte, after elution, is transferred to a separating device, especially high pressure liquid chromatography device, capillary electrophoresis device or liquid chromatography device.

72. The method according to claim 71, characterized in that the analyte is atomized by an electrospray device when exiting the support materials receiving unit after the separation into its components.
